(19) United States
(12) Patent Application Publication
(10) Pub. No.: US 2003/0167687 A1
(43) Pub. Date: Sep. 11, 2003

(54) Plant holder for use with a block wall

(76) Inventors: Tessa Jo Trass, Redmond, OR (US); David Roger Trass, Redmond, OR (US)

Correspondence Address: Glenn C. Brown, P.C., Suite 308, 777 N.W. Wall Street, Bend, OR, 97701, US

(21) Appl. No.: 10/410,056

(22) Filed: Apr. 8, 2003

Related U.S. Application Data
(63) Continuation of application No. PCT/US02/29159, filed on Sep. 13, 2002.
(60) Provisional application No. 60/322,068, filed on Sep. 13, 2001.

(51) Int. Cl. A47G 7/02; A01G 9/02

(52) U.S. Cl. 47/67; 248/314

(57) ABSTRACT

A bracket having a support member that can be removeably inserted into a seam between adjacent wall-forming elements that have been stacked to form a wall. A hanger portion connected to the support member is shaped to support a planter, vase, sign, or other item to be displayed.

### CROSS REFERENCE TO RELATED APPLICATION

This application is a continuation of PCT patent application No. PCT/US02/29159, filed on Sep. 13, 2002, which is a continuation of U.S. provisional patent application serial No. 60/322,068, filed on Sep. 13, 2001. The priority of the prior applications are expressly claimed and their disclosure is hereby incorporated by reference in their entirety.

### BACKGROUND OF THE INVENTION

Many homeowners and business owners erect block walls to mark property boundaries, to serve as retaining walls, or for privacy. Typically, such walls are made by stacking preformed blocks or shaped stones row by row until the desired height is reached. In most cases, the blocks or stones are shaped on the top and bottom to stack neatly and evenly without the need for mortar. The face of each block is often shaped to provide an attractive pattern.

While such walls are very useful, it is very difficult to attach a plant hanger or holder to the wall. The material is not compatible with most adhesives, and it is difficult to otherwise mount a hanger on the wall without drilling or cutting into the surface. If the surface is drilled or cut it is permanently marred.

A need remains therefore for a hanger that can be used with a stacked block or stone wall that is easily attached and that can be removed and repositioned without damaging the wall.

### SUMMARY OF THE INVENTION

The present invention provides a hanger that can be easily and removeably mounted on a stacked block or stone wall, and that can be removed or repositioned without damaging the structure or appearance of the wall. Various embodiments of the invention include hangars that accommodate one or multiple plants. The plants can be contained in planters of various shapes and which are made of various materials. A hanger according to the invention includes a flattened distal portion that is generally flat and that is inserted into the seam between adjacent blocks. The flattened distal portion is thick enough to support the weight of the plant while also being thin enough to readily insert into the seam between adjacent blocks with a minimum of displacement of either block. Once inserted, the hanger is firmly fixed in place and will support a relatively heavy plant. Owing to its novel and non-obvious design, a hanger according to the invention can be readily removed from a first position on the wall and repositioned if desired, all without damaging the face of the wall or the seam between the adjacent blocks.

These and other features of the invention will now be described in greater detail by reference to the drawings.

### BRIEF DESCRIPTION OF THE DRAWINGS

FIG. 1 is a side view of a first embodiment of the invention.

FIG. 2 is a side view of a second embodiment of the invention.

FIG. 3 is a side perspective view of a third embodiment of the invention.

FIG. 4 is a front perspective view of a third embodiment of the invention.

FIG. 5 is a top view of the embodiment shown in FIG. 4.

FIG. 6 is a side perspective view of a fourth embodiment of the invention.

FIG. 7 is a top view of the embodiment shown in FIG. 6.

FIG. 8 is a perspective view of a fifth embodiment of the invention.

FIG. 9 is a front perspective view showing the embodiment of FIG. 8 installed on a block wall.

FIG. 10 is a side view showing the embodiment of FIG. 9 installed on a block wall.

FIG. 11 is another side view showing the embodiment of FIG. 9 installed on a block wall.

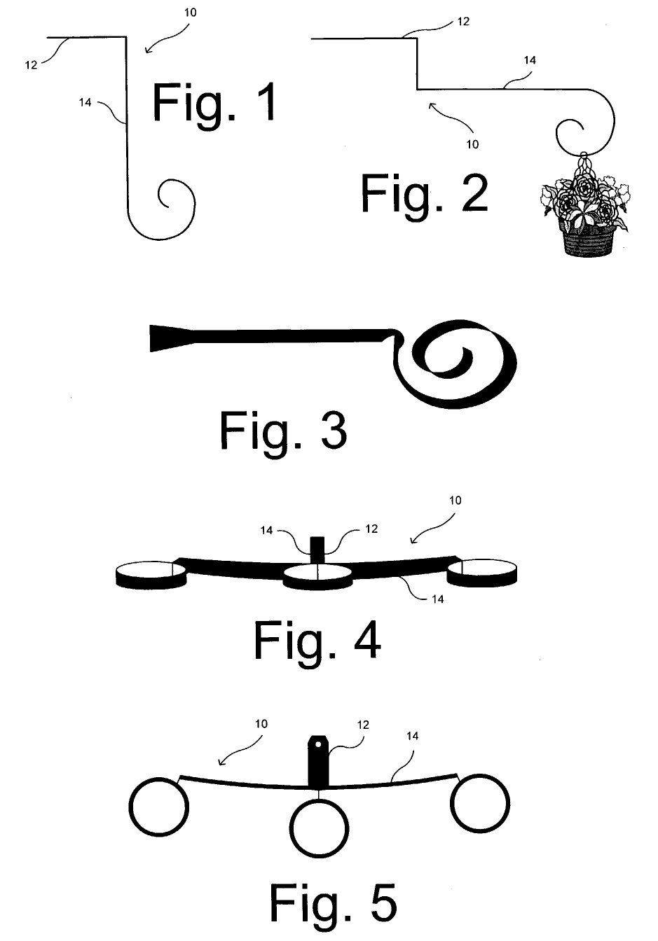

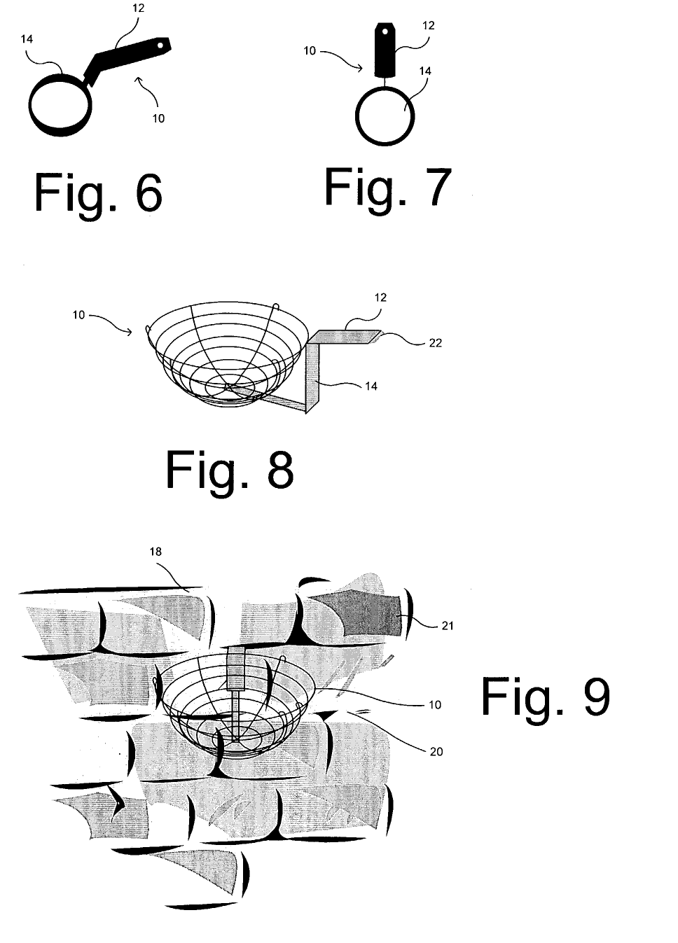

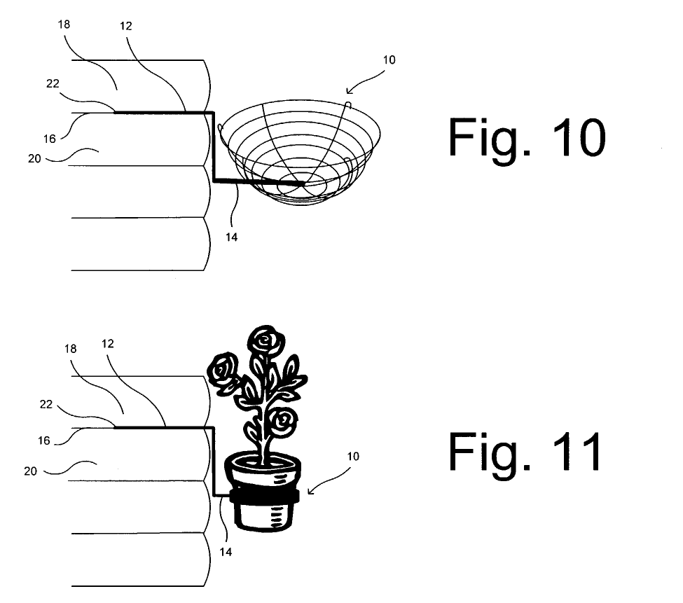

### DETAILED DESCRIPTION OF THE PREFERRED EMBODIMENT

This invention is embodied in an apparatus and a method that provides for the placement of planters, baskets, and miscellaneous decorative items on the faces of walls that are made from natural and formed stones, bricks, and blocks. The invention is embodied in various forms such as brackets, shelves, hangers or other supports for decorative items such as plants, and useful items such as signs.

The invention in one preferred embodiment incorporates the unique structure of retaining walls with a somewhat “Z” shaped design of the bracket. Referring to FIG.'s 1-3, a bracket according to the invention is shown generally at 10. Bracket 10 includes a support portion 12 and a hanger portion 14. Support portion 12 extends laterally from hanger portion 14, and is shaped to accommodate insertion into a seam between adjacent blocks. The word “blocks” will be used and illustrated for convenience, although the invention is not limited thereto. Blocks as used herein is intended to include blocks, bricks, stones, or tiles. Referring to FIG.'s 9 and 10, support 12 is pushed or driven into the seam 16 between adjacent blocks 18 and 20 that form wall 21. In preferred embodiments support 12 is a flattened metal member that includes a beveled or tapered front edge 22 to facilitate easy insertion into the wall. The support portion can also be formed in a shape similar to a piton shape (not shown). It should also be noted that a hanger according to the invention could also be installed while the blocks are being stacked to form the wall.

In the embodiments shown in FIG.'s 1, 2, 4, 5, 6, and 8, the hanger section 14 is formed at approximately a 90 degree angle from the support 12. In one method of using the invention, the support 12 is driven into wall 21 until the hanger portion 14 is adjacent the front surface of wall 21, which it is believed provides the most stable support. In other methods of use, the hanger portion 14 can be positioned away from wall if desired. The hanger portion 14 can take one of many forms, some of which are shown in FIG.'s 1-8. The invention can be used to support single or multiple planters or vases, or can be formed as a basket for use with ferns and mosses (FIG.'s 7, 8). In addition to those shown, other embodiments are possible such as a shelf in which a pair of spaced-apart supports are positioned at each end of a flat shelf (not shown). In another embodiment the hanger portion can support a sign that displays a business name or house number. Those of skill in the art will recognize that other embodiments are also possible without departing from the scope of the invention.

The material of construction for bracket 10 is preferably a hardened metal such as iron, steel, aluminum, plastic, or other materials that are capable of holding varying amounts of weight in different forms.

While the invention has been described above with reference to the illustrated preferred embodiments, those of skill in the art will recognize that numerous variations in detail and arrangement are possible without departing from the scope of the following claims.

What is claimed is:

1. An apparatus for supporting items on a wall assembled of discrete wall-forming elements, the apparatus comprising:
a generally flat support member having a thickness selected for insertion of the support member into a seam between adjacent wall-forming elements; and,
a hanger connected to the support member, the hanger including a portion shaped to support an item adjacent the face of the wall.

2. An apparatus for supporting items according to claim 1 wherein the hanger is formed to support an item selected from the group consisting of planters, vases, baskets, and signs.

3. An apparatus according to claim 1 wherein the support member includes a tapered forward edge.

4. An apparatus according to claim 1 wherein the hanger portion includes a vertical member connected to the support member.

5. An apparatus according to claim 1 wherein the hanger portion further includes a rounded member adapted for receiving a plant container.

6. An apparatus according to claim 5 wherein the hanger portion further includes a plurality of rounded members, at least one of which is adapted for receiving a plant container.

7. An apparatus according to claim 1 wherein the hanger portion includes a basket.

8. An apparatus according to claim 1 wherein the hanger portion further includes a shelf.

9. An apparatus according to claim 1 wherein the hanger portion further includes a support for engaging a sign.

10. An apparatus according to claim 1 wherein the support member is adapted for being removeably inserted into a seam between adjacent wall-forming elements.

11. An apparatus according to claim 1 wherein the wall-forming elements are selected from the group consisting of blocks, stones, bricks and tiles.

12. An apparatus according to claim 4 wherein at least a portion of the vertical member is positioned to rest against a front surface of the wall.

13. An apparatus according to claim 6 wherein the hanger portion further includes a lateral member interposed between the plurality of rounded members and the support member.

14. An apparatus according to claim 13 wherein the hanger portion further includes a vertical member interposed between the lateral member and the support member.

15. A wall adapted for displaying items adjacent a front surface of the wall comprising:
a plurality of stacked wall-forming members defining at least
a portion of a wall and further defining seams therebetween;
a bracket having a generally flat support member inserted into the seam between adjacent wall-forming elements; and,
a hanger connected to the support member, the hanger including a portion shaped to support an item adjacent the face of the wall.

16. An apparatus for supporting items according to claim 15 wherein the hanger is formed to support an item selected from the group consisting of planters, vases, baskets, and signs.

17. An apparatus according to claim 15 wherein the support member includes a tapered forward edge.

18. An apparatus according to claim 15 wherein the hanger portion includes a vertical member connected to the support member.

19. An apparatus according to claim 15 wherein the hanger portion further includes a rounded member adapted for receiving a plant container.

20. An apparatus according to claim 19 wherein the hanger portion further includes a plurality of rounded members, at least one of which is adapted for receiving a plant container.

21. An apparatus according to claim 15 wherein the hanger portion includes a basket.

22. An apparatus according to claim 15 wherein the hanger portion further includes a shelf.

23. An apparatus according to claim 15 wherein the hanger portion further includes a support for engaging a sign.

24. An apparatus according to claim 15 wherein the support member is adapted for being removeably inserted into a seam between adjacent wall-forming elements.

25. An apparatus according to claim 15 wherein the wall-forming elements are selected from the group consisting of blocks, stones, bricks and tiles.

26. An apparatus according to claim 18 wherein at least a portion of the vertical member is positioned to rest against a front surface of the wall.

27. An apparatus according to claim 20 wherein the hanger portion further includes a lateral member interposed between the plurality of rounded members and the support member.

28. An apparatus according to claim 27 wherein the hanger portion further includes a vertical member interposed between the lateral member and the support member.
